(19) United States
(12) Patent Application Publication
(10) Pub. No.: US 2019/0022953 A1
(43) Pub. Date: Jan. 24, 2019

(54) PLASTICS WELDING METHOD AND APPARATUS

(71) Applicant: Henry William LEE, Sandton (ZA)

(72) Inventor: Henry William LEE, Sandton (ZA)

(21) Appl. No.: 15/750,642

(22) PCT Filed: Aug. 5, 2016
(86) PCT No.: PCT/ZA2016/050029

§ 371 Date: Feb. 6, 2018

(30) Foreign Application Priority Data
Aug. 7, 2015 (ZA) 2015/05688

(51) Int. Cl. B29C 65/08; B29C 65/74; B29C 65/00; B26D 7/08; B26D 7/18

(52) U.S. Cl. CPC B29C 65/08; B29C 65/7443; B29C 66/1222; B29C 66/53243; B29L 2031/7158; B29C 66/81425; B26D 7/086; B26D 7/1863; B29C 66/612

(57) ABSTRACT

The invention provides a tool 10 of the invention for welding a PET gland 12 onto a PET bottle 14 for the fitment of a dispensing tap. The tool 10 is generically indicated as ultrasonic horn or sonotrode in the figure. The ultrasonic horn has a tapered serrated portion 16 which has a lead-in taper section 18 to initiate the melt of the plastics to be welded, and a knife section 20 (when required), being the cutting zone thereof, which in use cuts open a sealed spigot 22 so that the horn can enter into the spigot 24 for the welding operation.

### FIELD OF THE INVENTION

The invention relates to the welding of plastics, in particular it relates to the welding of PET to a PET bottle.

### BACKGROUND OF THE INVENTION

The inventor is aware that up to now it has been extremely difficult if not impossible to secure a dispensing tap to a PET bottle, such as a 51 water bottle, as it would be required to insert a backing plate of some sort into the bottle and then secure the dispensing tap or a gland on which it can be secured thereto.

Having considered this problem, the inventor now proposes the following solution.

### SUMMARY OF THE INVENTION

According to a first aspect of the invention there is provided a tapered ultrasonic welding tool or horn designed to weld a plastics material gland onto a spigot of a plastics material to which said gland can be welded, said tool including a serrated tapered portion which, in use, is urged from the outside into the spigot opening and melts the plastic materials of the spigot and the gland at the point of contact between the spigot, the gland, and the welding tool, so that the gland is welded to the outside of the spigot.

The spigot may be a portion of a blow moulded plastics bottle.

A tap portion may be secured to the gland as needed.

The spigot is thus the backup support for the gland which has never been done before.

The plastics material of the gland and/or the spigot may a thermoplastics material such as PET, polypropylene, polyethylene, nylon, or the like.

The invention extends to a cutting tool portion being provided on the leading edge or face of the welding tool so that, when the spigot is closed at one end typically due to the production process, the welding tool has a cutting tool portion, which could be ultrasound, at its face for cutting an opening into the spigot to permit the welding tool to enter into the spigot for the welding operation of the gland onto the spigot.

The rate at which the tapered portion of the tool is urged into the spigot opening is adjustable and independent of the cutting tool portion rate of advance i.e. the tapered portion and cutting tool portions have independently adjustable rates of displacement.

The welding tool and the cutting tool portion may be displaced in radial or axial directions.

The piece of spigot which has been cut out by the cutting tool should not end up in the bottle and thus a suction means may be provided on the leading edge of the welding tool thereby to suck the cut out disk shaped portion of the spigot and to secure it to the welding tool until the welding tool is withdrawn from the spigot at the completion of the welding.

The suction may be achieved by providing an aperture at the leading edge of the welding tool which is linked to a vacuum source thereby to cause a suction.

Where the cutting tool is ultrasonic and the welding is ultrasonic, the cutting requires a very different amplitude of ultrasound than the welding and thus the amplitude of the ultrasound is programmable to be variable between the cutting and the welding steps.

Thus, typically the cutting needs a higher amplitude than the welding amplitude.

According to a second aspect of the invention, there is provided a method for welding a plastics material gland onto a spigot of a plastics material, said method including urging a welding tool including a serrated tapered portion into the spigot opening and melting the plastics materials of the spigot and the gland at the point of contact between the spigot and the welding tool, so that the gland is welded to the outside of the spigot.

The method may include cutting an opening into the spigot to permit the welding tool to enter into the spigot for the welding operation of the gland onto the spigot, said cutting being performed by a cutting tool portion being provided on the leading edge or face of the welding tool so that, when the spigot is closed at one end typically due to the production process, the welding tool has a cutting tool portion, which could be ultrasound, at its face for cutting said opening into the spigot.

The method may include independently adjusting the rate at which the tapered portion of the welding tool is urged into the spigot opening and the rate at which the cutting tool portion rate is displaced.

The rate of advance of the welding tool and the cutting tool portion may be dictated by either the cutting tool portion required rate or the welding tool required rate.

The welding tool and the cutting tool portion may each be displaced in either radial or axial directions.

According to a further aspect of the invention, there is provided a blow moulded bottle having a mouth opening and a spigot on a side wall or base portion of the bottle remote from the mouth opening.

It would be known to those skilled in the art that in normal ultrasound welding applications, the leading edge or face of the welding tool is used for welding whereas in this invention the welding is done on the serrated tapered sides thereof and the leading edge or face is used for cutting the closed end of the spigot.

### DESCRIPTION OF AN EMBODIMENT OF THE INVENTION

The invention will now be described, by way of non-limiting example only, with reference to the accompanying diagrammatic drawings which shows a welding and cutting tool broadly in accordance with the invention.

In the drawings,

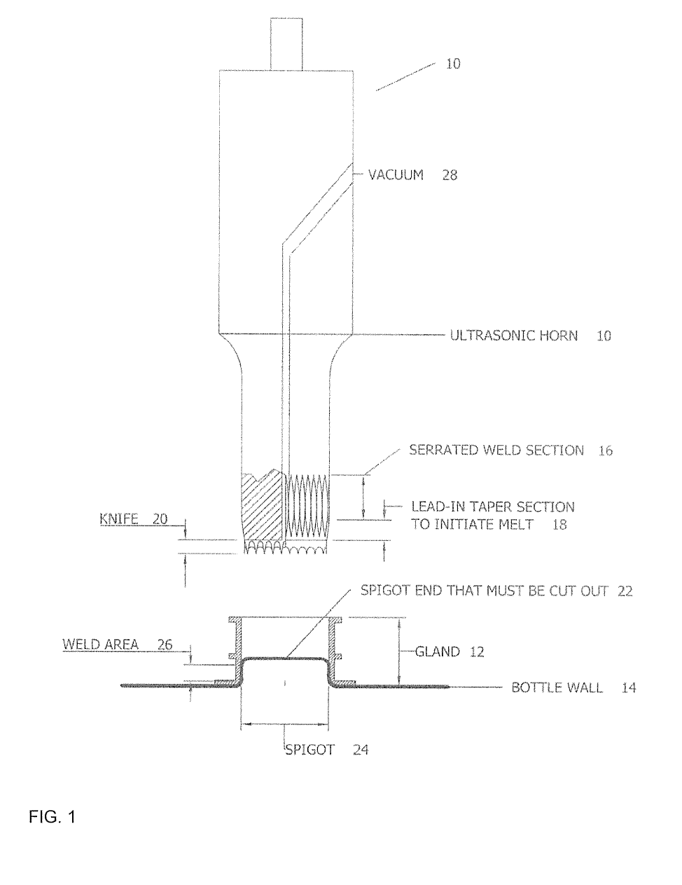

FIG. 1 shows a welding tool of the invention; and

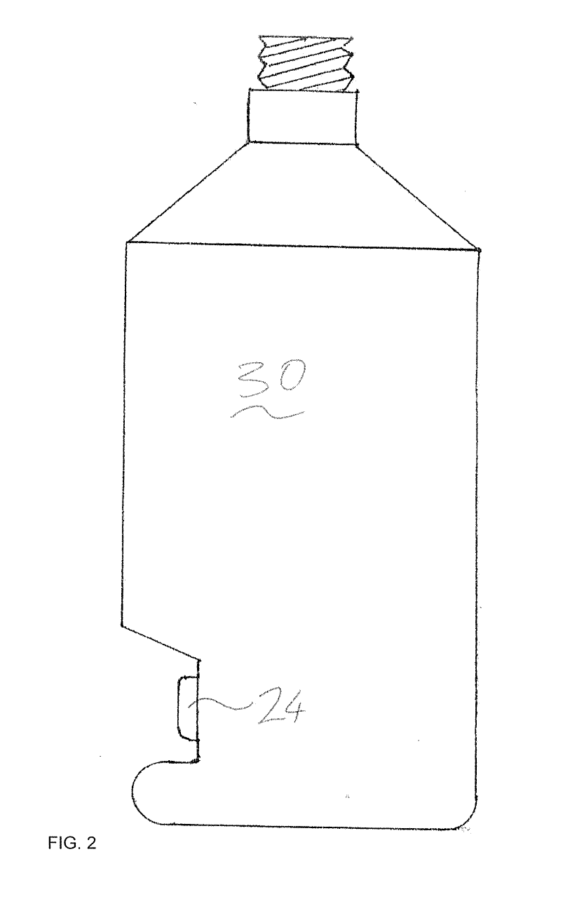

FIG. 2 shows a typical bottle having the gland welded thereto by the method and tools of the invention.

In FIG. 1 is shown a tool 10 of the invention in the process of welding a PET gland 12 onto a PET bottle 14 for the fitment of a dispensing tap. The tool 10 is generically indicated as ultrasonic horn or sonotrode in the figure.

Thus, the ultrasonic horn has a tapered serrated portion 16 which has a lead-in taper section 18 to initiate the melt of the plastics to be welded, and a knife section 20 (when required), being the cutting zone thereof, which in use cuts open a sealed spigot 22 so that the horn can enter into the spigot 24 for the welding operation.

The spigot is a portion of the bottom wall of the bottle and the gland is placed over the spigot with the tool cutting the closed end of the spigot and then the serrated portion enters into the spigot opening so that the spigot and the gland are welded together at the weld area 26 by the serrated portion 16 thereby securing the gland 12 in place without the need for a backing plate or support inside the bottle behind the spigot 24.

A tube connected to a vacuum source 28 leads through the horn to the cutting knife portion so that once the spigot has been cut open the disk which has been removed is sucked onto the horn and is extracted as the welding horn is withdrawn after welding has been completed.

FIG. 2 shows the bottle 30 including the spigot 24 to which the gland 12 may be welded by the tool 10 of FIG. 1.

It is an advantage of the invention that a single ultrasonic welding tool can be used to both cut the opening and weld the gland onto the spigot, while not requiring a backing plate or support in the bottle behind the spigot.

1. A tapered ultrasonic welding tool or horn designed to weld a plastics material gland onto a spigot of a plastics material to which said gland can be welded, said tool including a serrated tapered portion which, in use, is urged into the spigot opening from the outside and melts the plastic materials of the spigot and the gland at the point of contact between the spigot, the gland, and the welding tool, so that the gland is welded to the outside of the spigot.

2. A tapered ultrasonic welding tool or horn designed to weld a plastics material gland onto a spigot of a plastics material to which said gland can be welded as claimed in claim 1, wherein the spigot is a portion of a blow moulded plastics bottle.

3. A tapered ultrasonic welding tool or horn designed to weld a plastics material gland onto a spigot of a plastics material to which said gland can be welded as claimed in claim 1, wherein a tap portion is secured to the gland.

4. A tapered ultrasonic welding tool or horn designed to weld a plastics material gland onto a spigot of a plastics material to which said gland can be welded as claimed in claim 1, wherein the spigot is a backup support for the gland.

5. A tapered ultrasonic welding tool or horn designed to weld a plastics material gland onto a spigot of a plastics material to which said gland can be welded as claimed in claim 1, wherein the plastics material of the gland and/or the spigot is a thermoplastics material selected from PET, polypropylene, polyethylene, and nylon.

6. A tapered ultrasonic welding tool or horn designed to weld a plastics material gland onto a spigot of a plastics material to which said gland can be welded as claimed in claim 1, which includes a cutting tool portion being provided on the leading edge or face of the welding tool so that, when the spigot is closed at one end typically due to the production process, the welding tool has a cutting tool portion at its face for cutting an opening into the spigot to permit the welding tool to enter into the spigot for the welding operation of the gland onto the spigot.

7. A tapered ultrasonic welding tool or horn designed to weld a plastics material gland onto a spigot of a plastics material to which said gland can be welded as claimed in claim 6, wherein the cutting tool portion is an ultrasound cutter.

8. A tapered ultrasonic welding tool or horn designed to weld a plastics material gland onto a spigot of a plastics material to which said gland can be welded as claimed in claim 6, wherein the rate at which the tapered portion of the tool is urged into the spigot opening is adjustable and independent of the cutting tool portion rate of displacement.

9. A tapered ultrasonic welding tool or horn designed to weld a plastics material gland onto a spigot of a plastics material to which said gland can be welded as claimed in claim 8, wherein the welding tool and the cutting tool portion are displaced in radial or axial directions.

10. A tapered ultrasonic welding tool or horn designed to weld a plastics material gland onto a spigot of a plastics material to which said gland can be welded as claimed in claim 6, which includes a suction means provided on the leading edge of the welding tool thereby to suck the cut out disk shaped portion of the spigot and to secure it to the welding tool until the welding tool is withdrawn from the spigot at the completion of the welding.

11. A tapered ultrasonic welding tool or horn designed to weld a plastics material gland onto a spigot of a plastics material to which said gland can be welded as claimed in claim 10, wherein the suction is achieved by providing an aperture at the leading edge of the welding tool which is linked to a vacuum source thereby to cause a suction.

12. A tapered ultrasonic welding tool or horn designed to weld a plastics material gland onto a spigot of a plastics material to which said gland can be welded as claimed in claim 6, wherein where the cutting tool is ultrasonic and the welding is ultrasonic, the cutting requires a very different amplitude of ultrasound than the welding and thus the amplitude of the ultrasound is programmable to be variable between the cutting and the welding steps.

13. A tapered ultrasonic welding tool or horn designed to weld a plastics material gland onto a spigot of a plastics material to which said gland can be welded as claimed in claim 12, wherein the cutting needs a higher amplitude than the welding amplitude.

14. A method for welding a plastics material gland onto a spigot of a plastics material, said method including urging a welding tool including a serrated tapered portion into the spigot opening and melting the plastics materials of the spigot and the gland at the point of contact between the spigot and the welding tool, so that the gland is welded to the outside of the spigot.

15. A method as claimed in claim 14, which includes cutting an opening into the spigot to permit the welding tool to enter into the spigot for the welding operation of the gland onto the spigot, said cutting being performed by a cutting tool portion being provided on the leading edge or face of the welding tool so that, when the spigot is closed at one end typically due to the production process, the welding tool has a cutting tool portion, which could be ultrasound, at its face for cutting said opening into the spigot.

16. A method as claimed in claim 15, which includes independently adjusting the rate at which the tapered portion of the welding tool is urged into the spigot opening and the rate at which the cutting tool portion rate is displaced.

17. A method as claimed in claim 16, wherein the rate of advance of the welding tool and the cutting tool portion are dictated by either the cutting tool portion required rate or the welding tool required rate.

18. A method as claimed in claim 16, wherein the welding tool and the cutting tool portion are each displaced in either radial or axial directions.

19. (canceled)
